(19) United States
(12) Patent Application Publication
(10) Pub. No.: US 2014/0042723 A1
(43) Pub. Date: Feb. 13, 2014

(54) Axle Beam and Method of Manufacture

(71) Applicant: Gonzalo Luna, Lake Orion, MI (US)

(72) Inventor: Gonzalo Luna, Lake Orion, MI (US)

(73) Assignee: ARVINMERITOR TECHNOLOGY, LLC, Troy, MI (US)

(21) Appl. No.: 13/568,218

(22) Filed: Aug. 7, 2012

(51) Int. Cl. B60G 9/00; B21D 22/00

(52) U.S. Cl. 280/124.11; 72/352

(57) ABSTRACT

An axle beam and a method of manufacture. The axle beam may have a unitary construction that includes a beam portion and a boss portion. The boss portion may have first and second pins that are spaced apart from each other and spaced apart from the beam portion. The first and second pins may be coaxially disposed.

### TECHNICAL FIELD

The present application relates to an axle beam and a method of manufacture.

### BACKGROUND

A fabricated vehicle axle is disclosed in U.S. Pat. No. 7,862,058.

### SUMMARY

In at least one embodiment, a unitary axle beam is provided. The axle beam may have a beam portion that has a boss portion disposed at an end. The boss portion may have first and second pins. The first and second pins may be spaced apart from each other and may be spaced apart from the beam portion. The first and second pins may also be coaxially disposed.

In at least one embodiment, a method of making an axle beam is provided. The method may include forging a unitary axle beam having a beam portion and a boss portion. The boss portion may be disposed at an end of the beam portion and may have first and second pins that are coaxially disposed and extend in opposite directions from the boss portion. The method may also include hardening a portion of the first and second pins.

### BRIEF DESCRIPTION OF THE DRAWINGS

FIG. 1 is a perspective view of an exemplary steering knuckle and a unitary axle beam.

FIG. 2 is a side section view of the steering knuckle and unitary axle beam.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

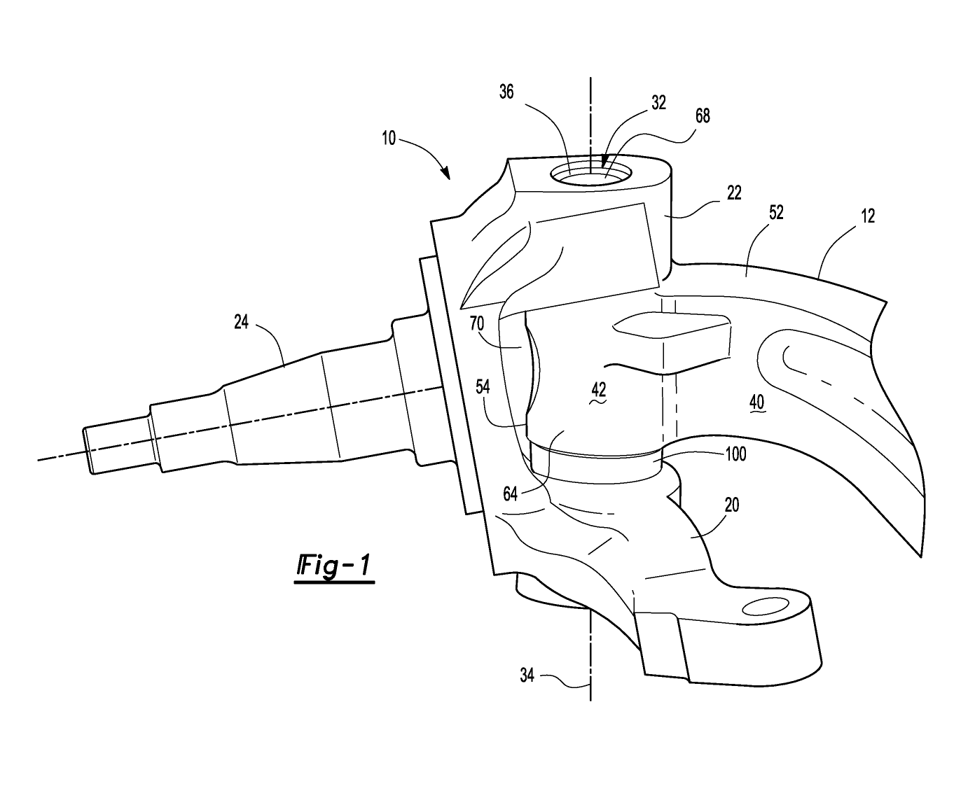

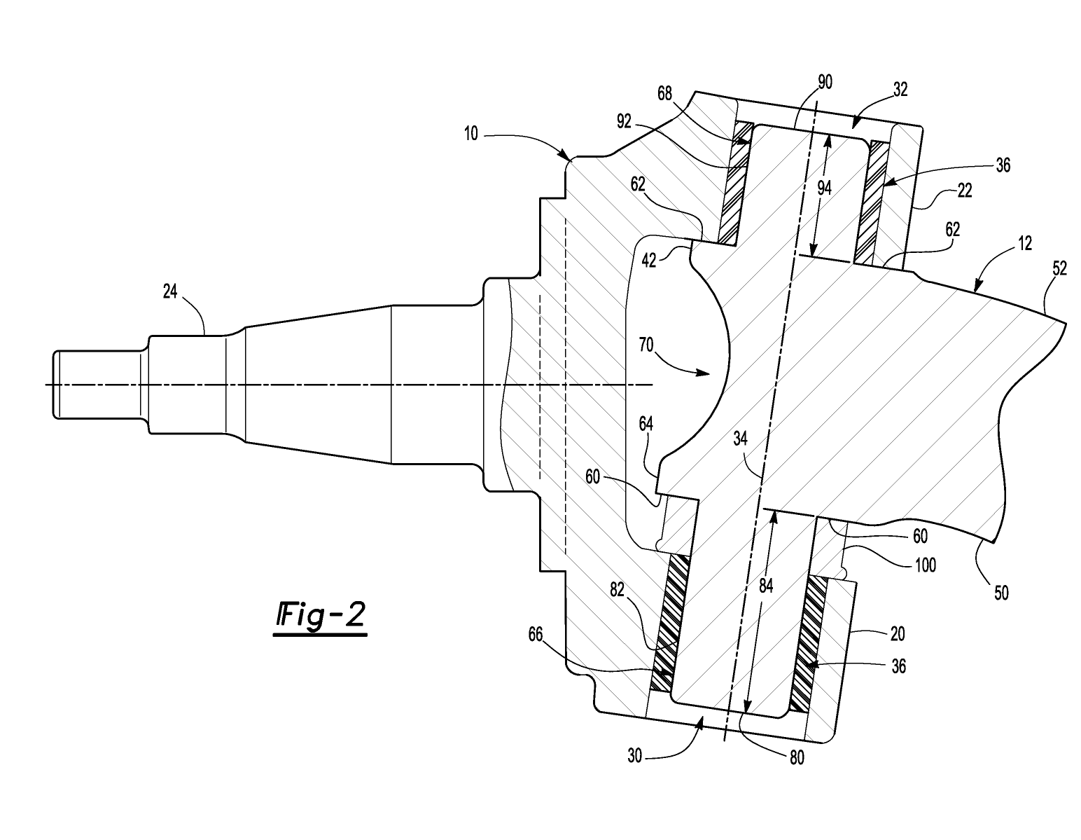

Referring to FIGS. 1 and 2, an exemplary steering knuckle 10 and axle beam 12 are shown. The steering knuckle 10 and axle beam 12 may be provided with a motor vehicle, such as a truck, bus, farm equipment, military transport or weaponry vehicle, or cargo loading equipment for land, air, or marine vessels.

The steering knuckle 10 may interconnect the axle beam 12 to a vehicle wheel and may be part of a steering system that may steer or change the direction of travel of the vehicle. The steering knuckle 10 may be provided with a multi-piece construction to facilitate assembly to the axle beam 12. In at least one embodiment, the steering knuckle 10 may include a first arm 20, a second arm 22, and a spindle 24.

The first and second arms 20, 22 may be spaced apart from each other and may include first and second holes 30, 32, respectively. The first and second holes 30, 32 may be coaxially disposed or aligned along an axis 34. In addition, the first and second holes 30, 32 may each receive a bearing assembly 36 that may facilitate rotation of the steering knuckle 10 about the axis 34 and with respect to the axle beam 12.

The spindle 24 may support a wheel hub assembly that facilitates mounting and rotation of a vehicle wheel. More specifically, the spindle 24 may support one or more wheel bearings that support and facilitate rotation of a vehicle wheel. The spindle 24 may extend along a second axis that extends away from the axle beam 12. The spindle 24 may be integrally formed or cast with the first and/or second arms 20, 22 such that the spindle 24 is not a separate component. Alternatively, the spindle 24 may be provided as a separate component that is fastened to the steering knuckle 10 in one or more embodiments.

The axle beam 12 may have a unitary one-piece construction. The axle beam 12 may be made of any suitable material, such as a metal or metal alloy. In at least one embodiment, the axle beam 12 may be a forging. The axle beam 12 may include a beam portion 40 and a boss portion 42.

The beam portion 40 may be configured to be mounted to the vehicle. The beam portion 40 may include a first axle beam surface 50, a second axle beam surface 52, and at least one end 54. In the embodiment shown, the first axle beam surface 50 may be located at or near the bottom of the beam portion 40. The second axle beam surface 52 may be disposed opposite the first axle beam surface 50. The end 54 may be disposed proximate the steering knuckle 10 and may be spaced apart from the vehicle. The beam portion 40 or a portion thereof may have a generally I-shaped cross section.

The boss portion 42 may be disposed at an end 54 of the beam portion 40. As such, the boss portion 42 may be integrally formed with the beam portion 40. The boss portion 42 may include a first surface 60, a second surface 62, an outer surface 64, a first pin 66, and a second pin 68.

The first surface 60 may face toward the first arm 20. In at least one embodiment, the first surface 60 may extend around the first pin 66 and may be substantially planar. The first surface 60 may be offset or spaced apart from the first axle beam surface 50 of the beam portion 40.

The second surface 62 may be disposed opposite the first surface 60 and may face toward the second arm 22. In at least one embodiment, the second surface 62 may extend around the second pin 68 and may be substantially planar. The second surface 62 may be offset or spaced apart from the second axle beam surface 52 of the beam portion 40. In addition, the second surface 62 may be disposed substantially parallel to the first surface 60 in one or more embodiments.

The outer surface 64 may extend from the first surface 60 to the second surface 62. The outer surface 64 may be curved and a portion of the outer surface 64 may be radially disposed with respect to the axis 34 in one or more embodiments. A recess 70 may be provided in the outer surface 64. For example, a recess 70 may be disposed between or spaced apart from the first and second surfaces 60, 62 and may extend toward the axle beam 12 or axis 34. The recess 70 may be concave and may reduce the weight of the axle beam 12 and/or provide additional clearance.

The first and second pins 66, 68 may couple the axle beam 12 to the steering knuckle 10 such that the steering knuckle 10 may pivot about the axis 34 and the first and second pins 66, 68. More specifically, the first pin 66 may be disposed in a bearing assembly 36 that is disposed in the first hole 30 and the second pin 68 may be disposed in a bearing assembly 36 that is disposed in the second hole 32. The first and second pins 66, 68 may extend in opposite directions from the boss portion 42 and may be coaxially disposed, or centered along the axis 34 and may be integrally formed with the boss portion 42. In addition, the first and second pins 66, 68 may be spaced apart from each other and may be spaced apart from the beam portion 40.

The first pin 66 may extend from the first surface 60 of the boss portion 42. The first pin 66 may have a first end surface 80 and a side surface 82. The first end surface 80 may be disposed at an end of the first pin 66 and may be spaced apart from the first surface 60. The side surface 82 may extend between the first surface 60 and the first end surface 80. In at least one embodiment, the first pin 66 may have a generally cylindrical configuration. As such, the side surface 82 may be radially disposed with respect to the axis 34. The first pin 66 may have an axial length 84 that may extend or be measured from the first surface 60 to the first end surface 80.

The second pin 68 may extend from the second surface 62 of the boss portion 42. The second pin 68 may have a second end surface 90 and a side surface 92. The second end surface 90 may be disposed at an end of the second pin 68 and may be spaced apart from the second surface 62. In addition, the second end surface 90 may be disposed opposite the first end surface 80 and may be disposed substantially parallel to the first end surface 80 in one or more embodiments. The side surface 92 may extend between the second surface 62 and the second end surface 90. In at least one embodiment, the second pin 68 may have a generally cylindrical configuration. As such, the side surface 92 may be radially disposed with respect to the axis 34. The second pin 68 may have an axial length 94 that may be less than the axial length 84 of the first pin 66. The axial length 94 of the second pin 68 may extend or be measured from the second surface 62 to the second end surface 90.

A thrust bearing 100 may be provided between the axle beam 12 and the first arm 20 of the steering knuckle 10. The thrust bearing 100 may extend around the first pin 66 and may facilitate pivotal movement of the steering knuckle 10.

Various methods of making an axle beam 12 will now be described in more detail. In at least one embodiment, the axle beam 12 may be forged as a unitary component that includes a beam portion 40 and a boss portion 42 as previously discussed. As such, the beam portion 40, boss portion 42, and first and second pins 66, 68 may be provided as a single component. After forging, at least a portion of the first and second pins 66, 68 may be hardened or provided with a hardened portion, such as with induction hardening, to provide a more durable surface and increase wear resistance. For example, the entirety of the side surfaces 82, 92 of the first and second pins 66, 68 or a portion thereof may be hardened. As such, all or a portion of the circumference of the first and second pins 66, 68 may be hardened. Optionally, the first and second end surfaces 80, 90 may also be hardened in one or more embodiments. Material may be removed from the first and second pins 66, 68 after hardening. For instance, material may be removed from the side surface 82, 92 with a cutting tool using any suitable technique, such as turning, to provide desired dimensional and/or surface finish characteristics. In addition, material may be removed from one or more end surfaces 80, 90 with a cutting tool using any suitable technique, such as milling, to provide desired dimensional and/or surface finish characteristics.

Integrally forming first and/or second pins 66, 68 with the axle beam 12 may eliminate the use of a kingpin to couple an axle to a steering knuckle. Elimination of a kingpin also eliminates the associated manufacturing costs, assembly costs, and fasteners like draw keys and nuts that may be used to secure the kingpin to the axle beam. In addition, an axle beam may be provided without having to machine holes for the kingpin and associated fasteners, thereby further reducing manufacturing and assembly costs.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A unitary axle beam comprising:
a beam portion having a boss portion disposed at an end, wherein the boss portion has first and second pins that are spaced apart from each other and spaced apart from the beam portion, wherein the first and second pins are coaxially disposed.

2. The unitary axle beam of claim 1 wherein the beam portion has a I-shaped cross section.

3. The unitary axle beam of claim 1 wherein the first and second pins extend in opposite directions from the boss portion.

4. The unitary axle beam of claim 1 wherein the first and second pins are substantially cylindrical.

5. The unitary axle beam of claim 1 wherein the boss portion includes a first surface and a second surface disposed opposite the first surface, wherein the first pin extends from the first surface and the second surface extends from the second surface.

6. The unitary axle beam of claim 5 wherein the first surface is disposed substantially parallel to the second surface.

7. The unitary axle beam of claim 5 wherein the first and second surfaces are spaced apart from the beam portion.

8. The unitary axle beam of claim 5 wherein the axle beam includes a first axle beam surface and a second axle beam surface disposed opposite the first axle beam surface, wherein the first and second surfaces are offset from the first and second axle beam surfaces, respectively.

9. The unitary axle beam of claim 5 wherein the first pin includes a first end surface and the second pin includes a second end surface, wherein an axial length of the first pin from the first surface to the first end surface is greater than an axial length of the second pin from the second surface to the second end surface.

10. The unitary axle beam of claim 9 wherein the first and second end surfaces are disposed substantially parallel to each other.

11. The unitary axle beam of claim 5 wherein the boss portion includes an outer surface that extends from the first surface to the second surface.

12. The unitary axle beam of claim 11 wherein the outer surface further comprises a recess that is disposed between the first and second surfaces and extends toward the axle beam, wherein the recess is spaced apart from the first and second surfaces.

13. A method of making an axle beam comprising:
forging a unitary axle beam having a beam portion and a boss portion, wherein the boss portion is disposed at an end of the beam portion and has first and second pins that are coaxially disposed and extend in opposite directions from the boss portion; and
hardening a portion of the first and second pins.

14. The method of claim 13 wherein the step of hardening a portion of the first and second pins includes induction hardening a circumference of the first and second pins.

15. The method of claim 14 wherein the boss portion includes a first surface, wherein the first pin extends from the first surface and includes a first end surface, wherein the first pin is induction hardened between the first surface and the first end surface.

16. The method of claim 15 wherein the boss portion includes a second surface, wherein the second pin extends from the second surface and includes a second end surface, wherein the second pin is induction hardened between the second surface and the second end surface.

17. The method of claim 14 further comprising removing material from hardened portions of the first and second pins.

18. The method of claim 17 wherein the step of removing material includes removing material from a circumference of the first pin and a circumference of the second pin.

19. The method of claim 18 wherein the step of removing material includes removing material from a first end surface of the first pin and a second end surface of the second pin.

20. The method of claim 13 wherein the first pin has a greater axial length than the second pin.
